(19) United States
(12) Patent Application Publication
(10) Pub. No.: US 2005/0119888 A1
(43) Pub. Date: Jun. 2, 2005

(54) Information processing apparatus and method, and program

(76) Inventors: Keiichi Sakai, Kanagawa (JP); Tetsuo Kosaka, Yonezawa-shi Yamagata (JP)

Correspondence Address: FITZPATRICK CELLA HARPER & SCINTO, 30 ROCKEFELLER PLAZA, NEW YORK, NY, 10112, US

(21) Appl. No.: 10/497,499

(22) PCT Filed: Dec. 10, 2002
(86) PCT No.: PCT/JP02/12920

(30) Foreign Application Priority Data
Dec. 12, 2001 (JP) 2001-381697

(51) Int. Cl. G10L 13/00

(52) U.S. Cl. 704/258

(57) ABSTRACT

A GUI display module displays a contents image based on contents data within a display area, and a display portion switching input module instructs to change the display portion of the contents image within the display area. Based on this instruction input, a display portion switching module changes the display portion of the contents image within the display area. A synthesis text determination module determines data which is to undergo speech synthesis in the contents data on the basis of display portion information which is held by a display portion holding module and indicates the display portion. A speech synthesis module synthesizes speech of the data which is to undergo speech synthesis, and a speech output module outputs the synthesized synthetic speech.

### TECHNICAL FIELD

The present invention relates to an information processing apparatus and method for controlling information display and speech input/output on the basis of contents data, and a program.

### BACKGROUND ART

With the fulfillment of infrastructures that use the Internet, an environment in which we can acquire new information (flow information) such as news generated every hour by common information devices is being put into place. It is often the case that such information device is operated mainly using a GUI (Graphic User Interface).

On the other hand, along with the advance of speech input/output techniques such as a speech recognition technology and text-to-speech technology and the like, a technique called CTI (Computer Telephony Integration) that replaces GUI operations by speech inputs using only audio modality such as a telephone or the like has advanced.

By applying such technique, a demand has arisen for a multimodal interface that uses both the GUI and speech input/output as a user interface. For example, Japanese Patent Laid-Open No. 9-190328 discloses a technique that reads aloud a mail message in a mail display window on a GUI using a speech output, indicates the read position using a cursor, and scrolls the mail display window along with the progress of the speech output of the mail message.

However, a multimodal input/output apparatus which can use both image display and speech input/output cannot appropriately control a speech output when the user has changed a display portion displayed on the GUI.

The present invention has been made in consideration of the aforementioned problems, and has as its object to provide a information processing apparatus and method, which can improve operability, and can implement appropriate information display and speech input/output in accordance with user's operations, and a program.

### DISCLOSURE OF INVENTION

In order to achieve the above object, an information processing apparatus according to the present invention comprises the following arrangement.

That is, an information processing apparatus for controlling information display and speech input/output on the basis of contents data, comprises:
display means for displaying a contents image based on the contents data within a display area;
input means for inputting a change instruction of a display portion of the contents image within the display area;
change means for changing the display portion of the contents image within the display area on the basis of an input from the input means;
display portion information holding means for holding display portion information indicating the display portion;
determination means for determining data, which is to undergo speech synthesis in the contents data, on the basis of the display portion information;
speech synthesis means for synthesizing speech of the data which is to undergo speech synthesis; and
speech output means for outputting synthetic speech synthesized by the speech synthesis means.

Preferably, the apparatus further comprises already output portion information holding means for holding already output portion information indicating the data which is to undergo speech synthesis, that has already been output by the speech output means, and
the determination means determines from the contents data second data which is to undergo speech synthesis other than first data which is to undergo speech synthesis and corresponds to the already output information.

Preferably, the apparatus further comprises re-output availability information holding means for holding re-output availability information indicating whether or not the data which is to undergo speech synthesis and has already been output as speech is to be re-output, and
the input means can input an input instruction of the re-output availability information.

Preferably, the apparatus further comprises already output portion information change means for changing the already output portion information held by the already output portion information holding means, and
the input means can input a change instruction of the already output portion information.

Preferably, the contents are described in a markup language and script language, and contain a description of control for an input unit that receives the input instruction of the re-output availability information.

Preferably, the contents are described in a markup language and script language, and contain a description of control for an input unit that receives the change instruction of the already output portion information.

In order to achieve the above object, an information processing method according to the present invention comprises the following arrangement.

That is, an information processing method for controlling information display and speech input/output on the basis of contents data, comprises:
the display step of displaying a contents image based on the contents data within a display area;
the input step of inputting a change instruction of a display portion of the contents image within the display area;
the change step of changing the display portion of the contents image within the display area on the basis of an input in the input step;
the determination step of determining data, which is to undergo speech synthesis in the contents data, on the basis of display portion information indicating the display portion;
the speech synthesis step of synthesizing speech of the data which is to undergo speech synthesis; and
the speech output step of outputting synthetic speech synthesized in the speech synthesis step.

In order to achieve the above object, a program according to the present invention comprises the following arrangement.

That is, a program for making a computer serve as an information processing apparatus for controlling information display and speech input/output on the basis of contents data, comprises:
a program code of the display step of displaying a contents image based on the contents data within a display area;
a program code of the input step of inputting a change instruction of a display portion of the contents image within the display area;
a program code of the change step of changing the display portion of the contents image within the display area on the basis of an input in the input step;
a program code of the determination step of determining data which is to undergo speech synthesis in the contents data on the basis of display portion information indicating the display portion;
a program code of the speech synthesis step of synthesizing speech of the data which is to undergo speech synthesis; and
a program code of the speech output step of outputting synthetic speech synthesized in the speech synthesis step.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example of the hardware arrangement of a multimodal input/output apparatus according to the first embodiment of the present invention;

FIG. 2 is a block diagram showing the functional arrangement of the multimodal input/output apparatus according to the first embodiment of the present invention;

FIG. 3 shows an example of contents according to the first embodiment of the present invention;

FIG. 4 shows a GUI display example according to the first embodiment of the present invention;

FIG. 5 shows an example of display portion information according to the first embodiment of the present invention;

FIG. 6 is a flow chart showing the process to be executed by the multimodal input/output apparatus according to the first embodiment of the present invention;

FIG. 7 shows a GUI display example according to the second embodiment of the present invention;

FIG. 8 shows another GUI display example according to the second embodiment of the present invention;

FIG. 9 is a block diagram showing the functional arrangement of a multimodal input/output apparatus according to the third embodiment of the present invention;

FIG. 10 is a flow chart showing the process to be executed by the multimodal input/output apparatus according to the third embodiment of the present invention;

FIG. 11 is a block diagram showing the functional arrangement of a multimodal input/output apparatus according to the fourth embodiment of the present invention;

FIG. 12 is a block diagram showing another functional arrangement of a multimodal input/output apparatus according to the fourth embodiment of the present invention;

FIG. 13 shows an example of contents according to the fifth embodiment of the present invention;

FIG. 14 shows another example of contents according to the fifth embodiment of the present invention; and

FIG. 15 shows a GUI display example according to the fifth embodiment of the present invention.

### BEST MODE FOR CARRYING OUT THE INVENTION

Preferred embodiments of the present invention will be described in detail hereinafter with reference to the accompanying drawings.

### First Embodiment

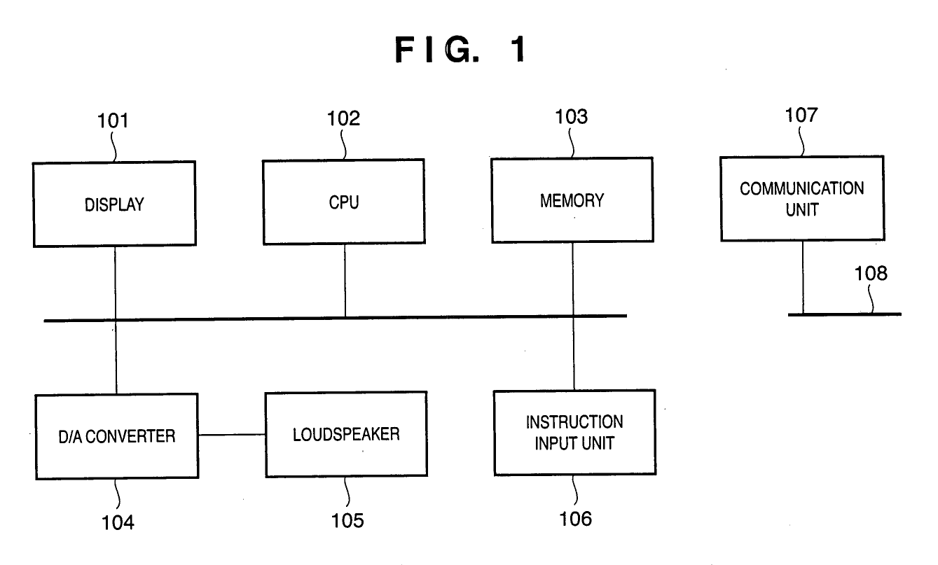

FIG. 1 is a block diagram showing an example of the hardware arrangement of a multimodal input/output apparatus according to the first embodiment of the present invention.

In the multimodal input/output apparatus, reference numeral 101 denotes a display for displaying a GUI. Reference numeral 102 denotes a CPU such as a CPU or the like for executing processes, e.g., numerical operations, control, and the like. Reference numeral 103 denotes a memory for storing temporary data and a program required for the processing sequence and processes in each embodiment to be described later, and various data such as speech recognition grammar data, speech models, and the like. This memory 103 comprises an external memory device such as a disk device or the like, or an internal memory device such as a RAM, ROM, or the like.

Reference numeral 104 denotes a D/A converter for converting a digital speech signal into an analog speech signal. Reference numeral 105 denotes a loudspeaker for outputting the analog speech signal converted by the D/A converter 104. Reference numeral 106 denotes an instruction input unit for inputting various data using a pointing device such as a mouse, stylus, or the like, various keys (alphabet keys, ten-key pad, arrow buttons given to it, and the like), or a microphone that can input speech. Reference numeral 107 denotes a communication unit for exchanging data (e.g., contents) with an external apparatus such as a Web server or the like. Reference numeral 108 denotes a bus for interconnecting various building components of the multimodal input/output apparatus.

Various functions (to be described later) to be implemented by the multimodal input/output apparatus may be implemented by executing a program stored in the memory 103 of the apparatus by the CPU 102 or by dedicated hardware.

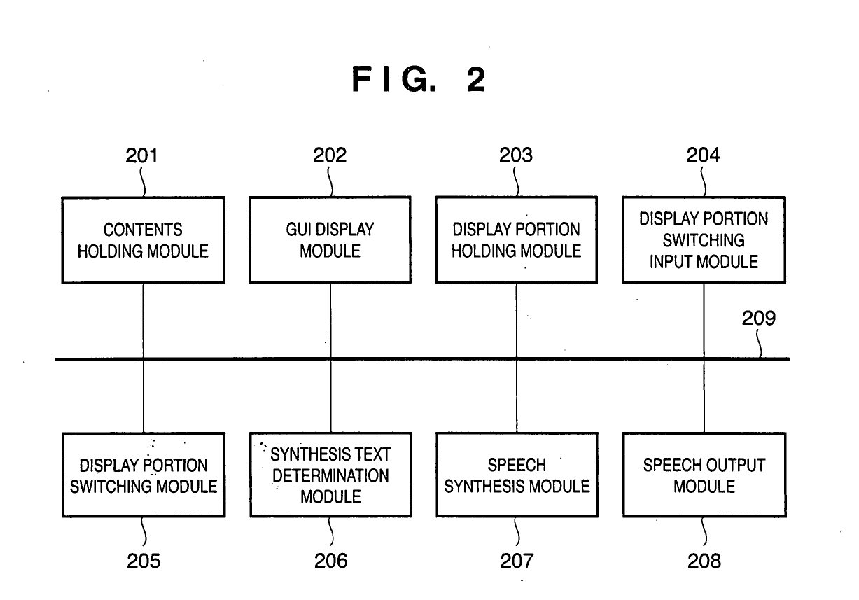

FIG. 2 is a block diagram showing the functional arrangement of the multimodal input/output apparatus according to the first embodiment of the present invention.

Referring to FIG. 2, reference numeral 201 denotes a contents holding module for holding the contents of a GUI to be displayed on the display 101. The contents holding module 201 is implemented by the memory 103. The contents to be held by the contents holding module 201 may be described using a program, or may be hypertext documents described in markup languages such as XML, HTML, SGML, and the like.

Reference numeral 202 denotes a GUI display module for displaying the contents held by the contents holding module 201 on the display 101 as a GUI. The GUI display module 202 is implemented by, e.g., a browser or the like. Reference numeral 203 denotes a display portion holding module for holding display portion information that indicates the display portion of the contents displayed by the GUI display module 202. This display portion holding module 203 is also implemented by the memory 103.

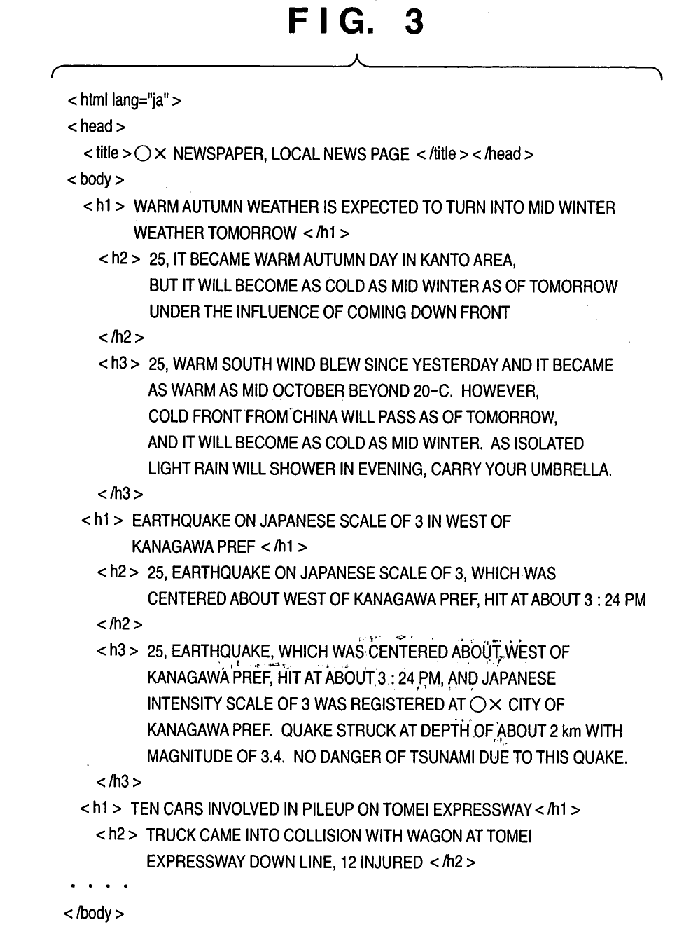

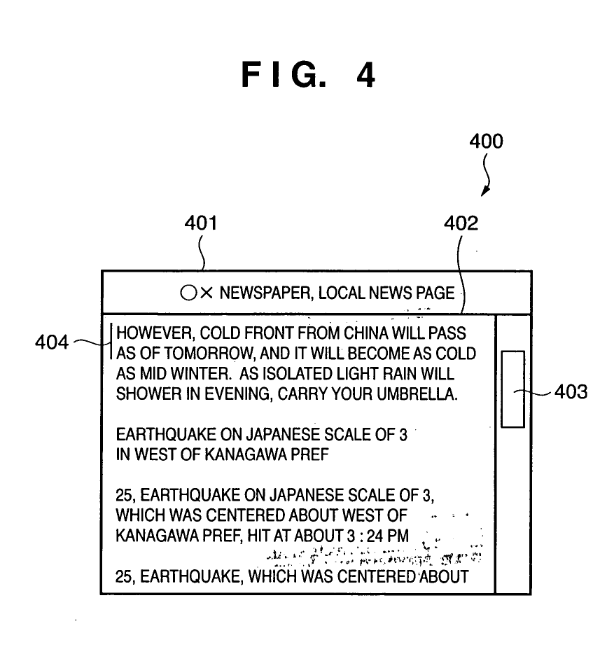

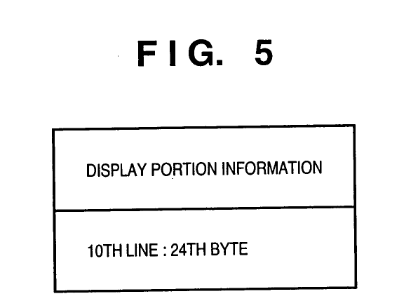

FIG. 3 shows an example of the contents which are held by the contents holding module 201 and are described in HTML, FIG. 4 shows a GUI display example of the contents on the GUI display module 202, and FIG. 5 shows an example of display portion information held by the display portion holding module 203 in correspondence with that GUI display example.

Referring to FIG. 4, on a display area (e.g., browser window) 400 on which the GUI display module 202 displays contents, reference numeral 401 denotes a contents header; 402, a contents body; 403, a scroll bar used to vertically scroll the display portion of the contents; and 404, a cursor in the contents.

FIG. 5 shows the head position (24th byte in the 10th line in FIG. 3) as display portion information to be held by the display portion holding module 203.

Note that the display portion information may be held as the total number of bytes from the head of the contents in place of the above information, and the format of display portion information to be held is not particularly limited as long as information can specify the display portion such as the number of sentences, the number of sentences and the number of clauses, the number of sentences and the number of characters, or the like from the head of the contents. Also, the present invention is not limited to information of the head position, and text data which is to undergo speech synthesis within the display portion may be held intact. When the contents include some frames like a hypertext document, the head position of a default frame or a frame explicitly selected by the user is used as the display portion information.

The description will revert to FIG. 2.

Reference numeral 204 denotes a display portion switch input module for inputting a display portion switch instruction from the instruction input unit 106. Reference numeral 205 denotes a display portion switch module for switching the display portion information held by the display portion holding module 203 on the basis of the display portion switch instruction input by the display portion switch input module 204. Based on this display portion information, the GUI display module 202 updates the display portion of the contents to be displayed within the display area 400.

Reference numeral 206 denotes a synthesis text determination module for determining synthesis text (text data), which is to undergo speech synthesis in the contents, on the basis of the display portion information held by the display portion holding module 203. That is, the module 206 determines text data in the contents contained within the display portion specified by the display portion information as synthesis text which is to undergo speech synthesis.

Reference numeral 207 denotes a speech synthesis module for executing speech synthesis of the synthesis text determined by the synthesis text determination module 206. Reference numeral 208 denotes a speech output module for converting a digital speech signal synthesized by the speech synthesis module 207 into an analog speech signal via the D/A converter 104, and outputting synthetic speech (analog speech signal) from the loudspeaker 105. Reference numeral 209 denotes a bus for interconnecting various building components shown in FIG. 2.

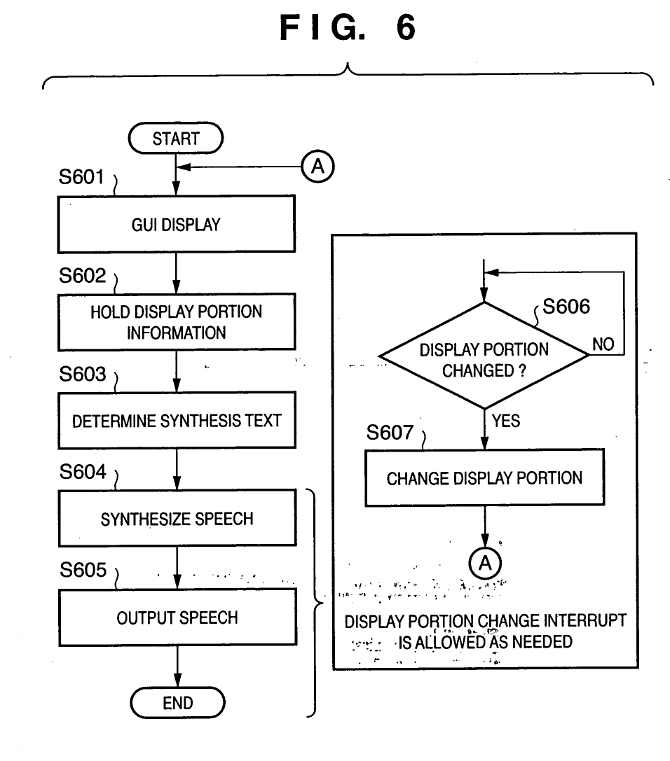

The process to be executed by the multimodal input/output apparatus of the first embodiment will be described below using FIG. 6.

FIG. 6 is a flow chart showing the process to be executed by the multimodal input/output apparatus according to the first embodiment of the present invention.

Note that steps S601 to S607 in the flow chart in FIG. 6 are executed under the control of the CPU 102.

In step S601, the contents held by the contents holding module 201 are displayed by the GUI display module 202. In step S602, the display portion (e.g., the upper left position) of the contents displayed by the GUI display module 202 is acquired to hold the display portion information in the display portion holding module 203. In step S603, the synthesis document determination module 206 determines synthesis text, which is to undergo speech synthesis, in the contents, and sends the determined text to the speech synthesis module 207.

In step S604, the speech synthesis module 207 makes speech synthesis of the synthesis text which is received from the synthesis document determination module 206 and is to undergo speech synthesis. In step S605, the speech output module 208 outputs the synthetic speech from the loudspeaker 105, thus ending the process.

Note that the user can change the display portion using the instruction input unit 106 between step S604 and “END”, and a process for detecting the presence/absence of such change is executed in step S606.

If it is determined in step S606 that the user changes the display portion by dragging the scroll bar 403 using, e.g., a pointing device or pressing a given arrow key on the keyboard with respect to the cursor 404 (YES in step S606), the flow advances to step S607. In step S607, the process in step S604 or S605, which is executed when the display portion change instruction has been issued, is aborted, and the display portion is then changed. After that, the flow returns to step S601.

Note that effect sound (e.g., squeaky sound) like that produced upon fastforwarding or rewinding a tape in a cassette tape recorder may be audibly output to inform the user that the display portion is being changed during that process.

In the first embodiment, the scroll bar 403 is used to vertically scroll the contents within the display area 400. Also, a horizontal scroll bar used to horizontally scroll the contents may be added to partially display the contents in the horizontal direction.

However, since a part of the contents, which is not displayed in the horizontal direction, is normally connected to the displayed part of the contents, a text part within the non-display portion defined by the horizontal scroll bar undergoes speech synthesis.

Note that the process explained in the first embodiment may be applied to an object which is independent from the displayed part (e.g., text in the form of table or the like) when the contents display portion has been changed by the horizontal scroll bar.

Furthermore, the size of the display area 400 is fixed in the above description. However, the size of the display area 400 can be changed by dragging by means of a pointing device, or pressing a key on the keyboard with respect to the cursor 404. The process described in the first embodiment can be similarly applied when the size of the display area 400 itself has been changed to change the contents display portion.

As described above, according to the first embodiment, even when the display portion has been changed during speech synthesis/output of synthesis text, which is indicated within the display portion and is to undergo speech synthesis, the speech output contents can be changed in accordance with a change in synthesis text which is displayed within the changed display portion and is to undergo speech synthesis. In this manner, natural speech output and GUI display can be presented to the user.

### Second Embodiment

When contents are output on a portable terminal with a relatively small display screen such as an i-mode terminal (a terminal (typically, a portable phone) that can subscribe to the i-mode service provided by NTT DoCoMo Inc.), a PDA (Personal Digital Assistant), or the like, an output method in which only a summary part of the contents to be displayed is displayed on a GUI, and a detailed part is not displayed on the GUI but is output as synthetic speech may be used.

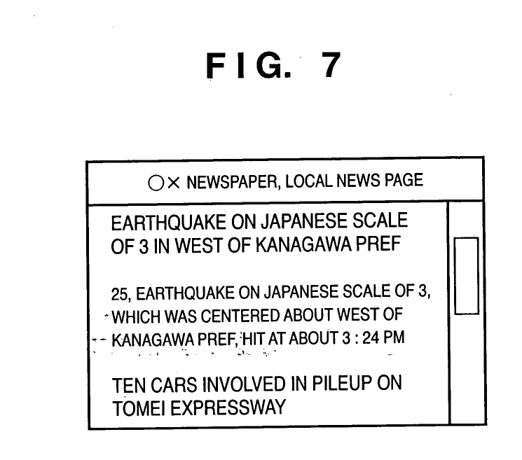

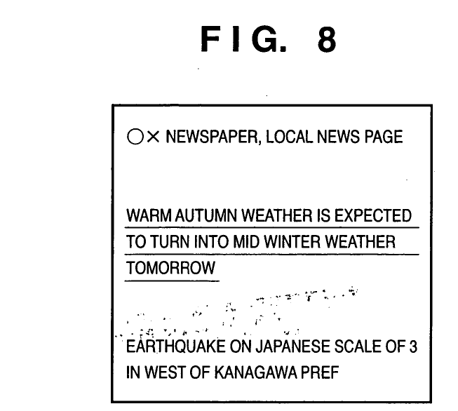

For example, cases will be explained below using FIGS. 7 and 8 wherein the contents example shown in FIG. 3 is respectively output on a portable terminal such as a PDA or the like, and on a portable terminal such as an i-mode terminal or the like.

FIG. 7 shows a GUI display example of the contents shown in FIG. 3 on the display screen of a portable terminal such as a PDA or the like, which has a larger display screen than a portable terminal such as an i-mode terminal or the like. Especially, a multimodal input/output apparatus that assumes a PDA displays, on a GUI, a headline part (text data bounded by <h1> and </h1> tags) corresponding to “headline” and a summary part (text data bounded by <h2> and </h2> tags) corresponding to “summary” in the contents shown in FIG. 3. Also, the apparatus does not display a detailed contents part (text data bounded by <h3> and </h3> tags) corresponding to “details” in the contents on the GUI, but outputs it using only synthetic speech.

FIG. 8 shows a GUI display example of the contents shown in FIG. 3 on the display screen of a portable terminal such as an i-mode terminal or the like, which has a smaller display screen than the portable terminal such as a PDA or the like. Especially, a multimodal input/output apparatus that assumes an i-mode terminal displays, on a GUI, a headline part (text data bounded by <h1> and </h1> tags) in the contents shown in FIG. 3. Also, the apparatus does not display a summary part (text data bounded by <h2> and </h2> tags) and a detailed contents part (text data bounded by <h3> and </h3> tags) on the GUI, but outputs them using only synthetic speech. Furthermore, the GUI display example in FIG. 8 does not use any scroll bar to express the displayed parts with respect to the entire contents, but displays a selected portion in the displayed part in a display pattern different from that of a non-selected portion so as to distinguish them from each other. For example, the selected portion is underlined, and the GUI display example in FIG. 8 indicates that the headline part corresponding to “headline” has been selected.

Note that the display pattern of the selected portion is not limited to the underline but is not particularly limited as long as it can be distinguished from the non-selected portion (e.g., the selected portion may be displayed in a different color, may blink, may be displayed using a different font or style, and so forth).

If the process described in the first embodiment using the flow chart in FIG. 6 is applied to such portable terminal, when synthesis text which is to undergo speech synthesis is not displayed on the GUI, the synthesis text which is to undergo speech synthesis can be changed in accordance with movement of the display portion using a pointing device with respect to the scroll bar or switching of the display screen using an arrow key from the instruction input unit 106.

In case of this arrangement, the display portion holding module 203 in FIG. 2 holds, as the display portion information, the head position of the currently displayed contents or text data of the headline and summary parts. The synthesis text determination module 206 determines text data obtained based on this display portion information as synthesis text which is to undergo speech synthesis.

As described above, according to the second embodiment, even when text data corresponding to synthetic speech to be output is not displayed on the display screen of the portable terminal with a relatively small display screen, the speech output contents can be changed in correspondence with movement or switching of the display screen. In this manner, natural speech output and GUI display can be presented to the user.

### Third Embodiment

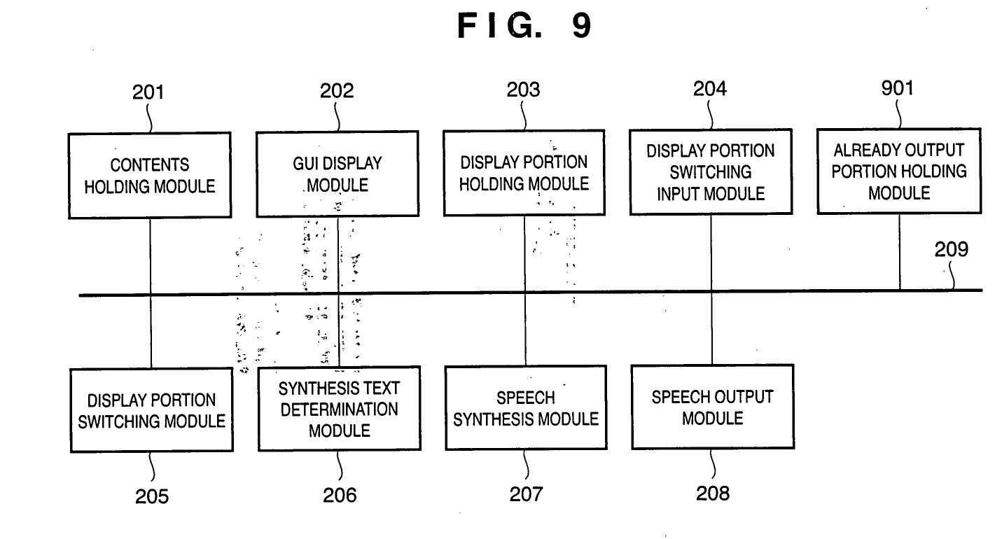

In the third embodiment, an already output portion holding module 901 that holds the portion that has already been output as speech in the contents is added to the functional arrangement of the multimodal input/output apparatus of the first embodiment shown in FIG. 2, as shown in FIG. 9. With this arrangement, the speech output of the portion held by the already output portion holding module 901 can be inhibited. Hence, the already speech output portion can be prevented from being output again, thus eliminating a redundant speech output.

Note that the already output portion holding module 901 is implemented by the memory 103.

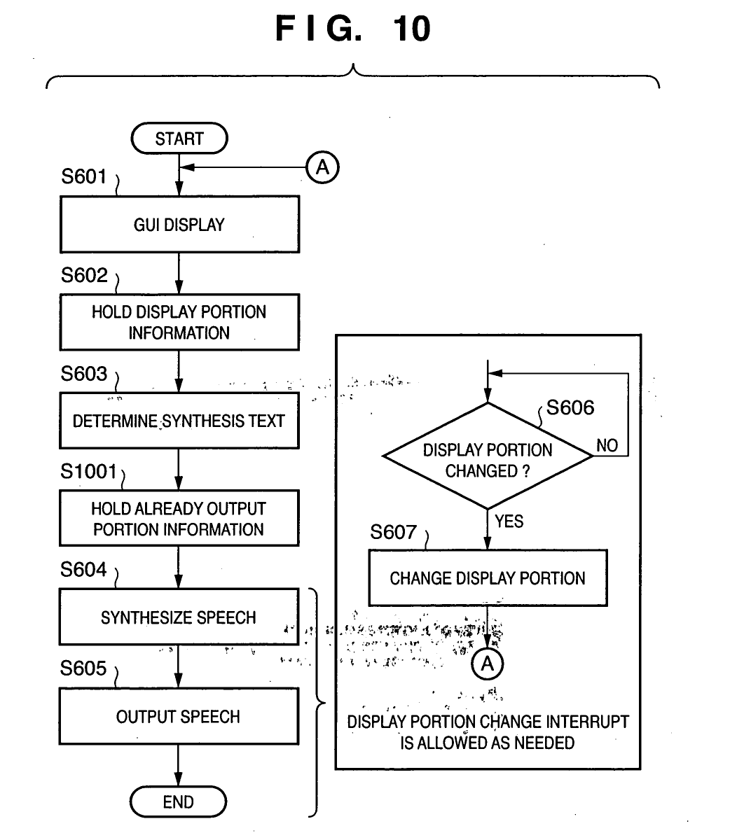

The process to be executed by the multimodal input/output apparatus of the third embodiment will be described below using FIG. 10.

FIG. 10 is a flow chart showing the process to be executed by the multimodal input/output apparatus according to the third embodiment of the present invention.

In the flow chart of FIG. 10, step S1001 is added between steps S603 and S604 in the flow chart of the first embodiment shown in FIG. 6.

In step S1001, already output portion information which indicates the already speech output portion is held by the already output portion holding module 901. After that, when the display portion has been changed, and the process in step S603 is repeated, the synthesis speech determination module 206 determines synthesis speech which is to undergo speech synthesis except for the already output synthesis speech with reference to the already output portion information held by the already output portion holding module 901.

In addition, in the process in step S601, the color or font of the already speech output portion is set to be different from that of the portion which has not been output as speech yet with reference to the already output portion information held by the already output portion holding module 901, thus presenting the presence/absence of the speech output portion using a user friendly interface.

Note that the already output portion information held by the already output portion holding module 901 is not particularly limited as long as it can specify the already speech output portion, as in the display portion information held by the display portion holding module 203.

As described above, according to the third embodiment, since the already speech output portion in the contents is held, when the speech output contents are to be changed in accordance with a change in display portion, the speech output contents can be determined by excluding that portion which has already been output as speech. In this manner, a redundant speech output can be excluded, and a user friendly and efficient contents output can be provided.

### Fourth Embodiment

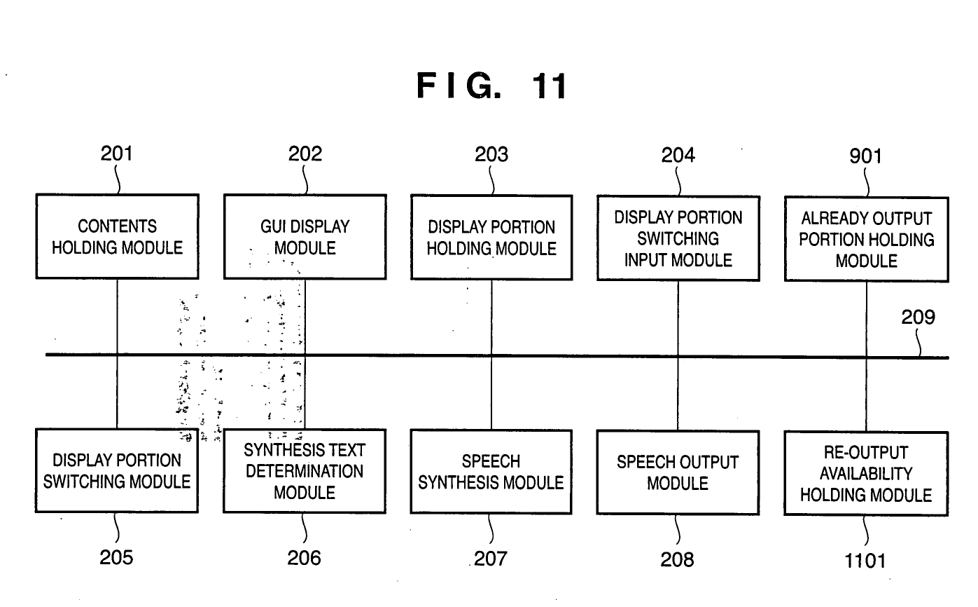

In the third embodiment, synthetic speech is inhibited from being output within the already speech output portion. Alternatively, the user may dynamically change whether or not the already speech output portion is output again as synthetic speech. In the fourth embodiment, in order to implement such arrangement, a re-output availability holding module 1101 that holds re-output availability information indicating if the already speech output portion is re-output as speech is added to the functional arrangement of the multimodal input/output apparatus of the third embodiment shown in FIG. 9, as shown in FIG. 11.

Input of this re-output availability information may be switched from a button, menu, or the like formed on the display area 400 in FIG. 4.

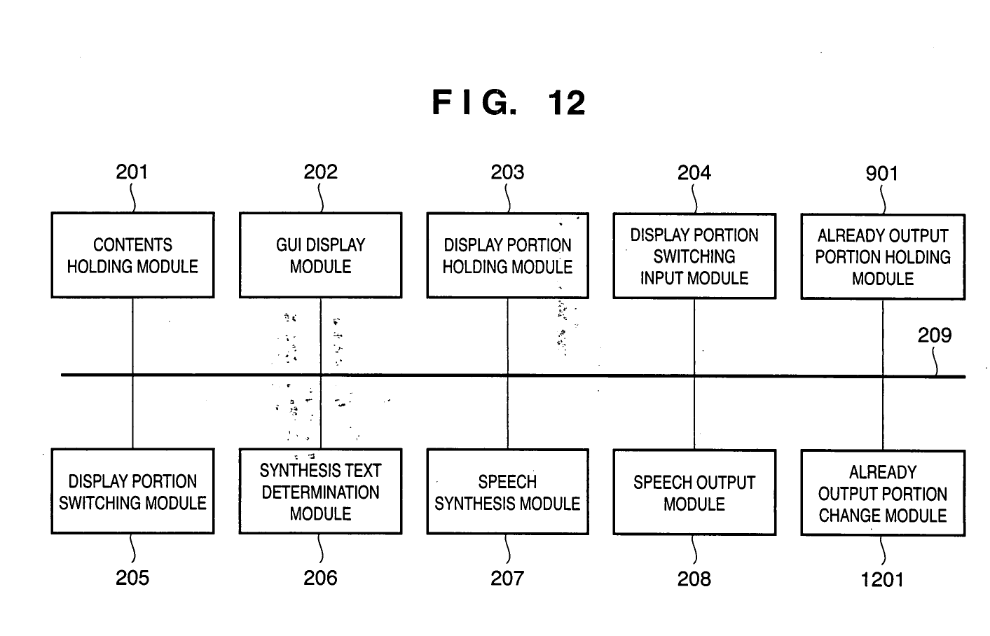

Alternatively, an already output portion change module 1201 that deletes the already output portion information held by the already output portion holding module 901 upon receiving a re-output instruction of the already speech output portion from the instruction input unit 106 may be added, as shown in FIG. 12.

As described above, according to the fourth embodiment, the already speech output portion can be output again as speech in accordance with a user's request in addition to the effects described in the third embodiment.

### Fifth Embodiment

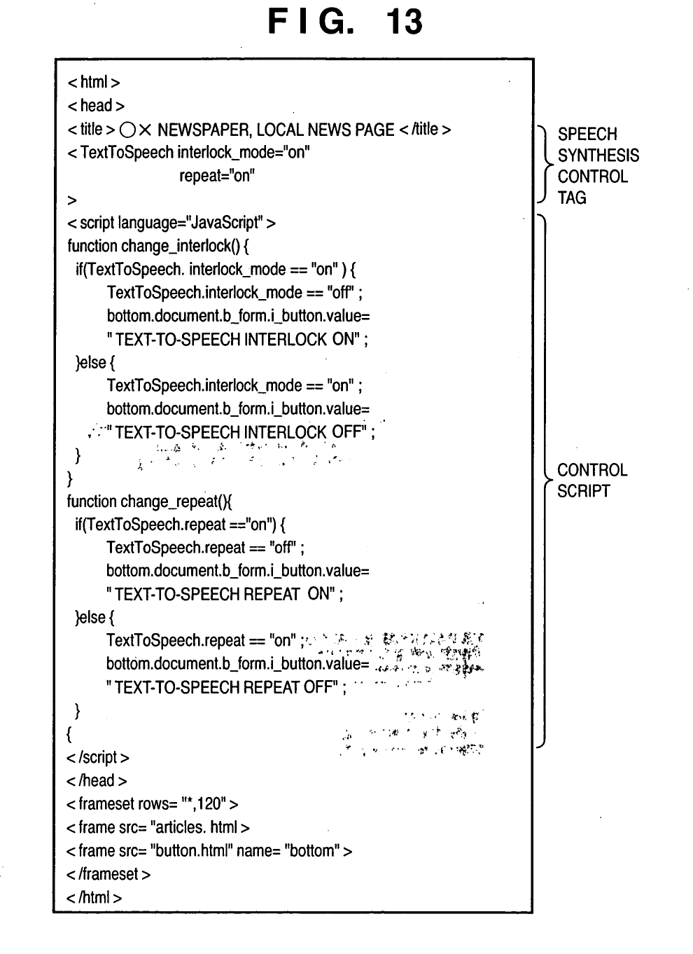

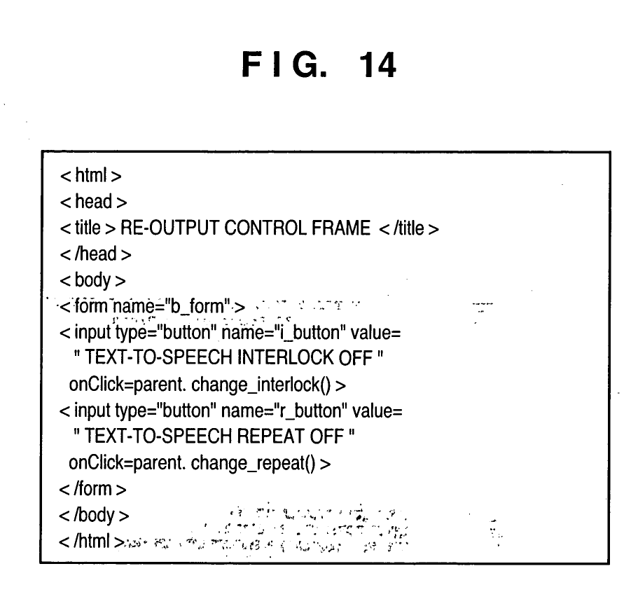

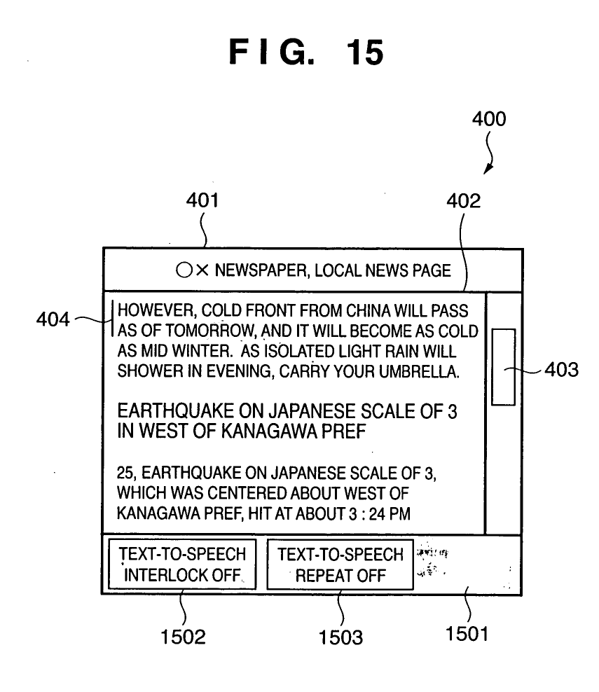

The processes explained in the first to fourth embodiments may be implemented by setting them as tags of a markup language in the contents. In order to implement such arrangement, FIGS. 13 and 14 show contents examples described using a markup language, and FIG. 15 shows a GUI display example based on the contents shown in FIGS. 3, 13, and 14.

A part bounded by speech synthesis control tags “<TextToSpeech” and “>” in FIG. 13 describes control associated with speech synthesis. The on/off states of an interlock_mode attribute and repeat attribute in the part bounded by the speech synthesis control tags define whether or not the speech output and display of synthesis text which is to undergo speech synthesis are to be interlocked, and whether or not the already speech output portion is to be re-output as synthetic speech.

That is, if the interlock_mode attribute is “on”, the speech output and display of synthesis text which is to undergo speech synthesis are interlocked; if it is “off”, they are not interlocked. On the other hand, if the repeat attribute is “on”, the already speech output portion undergoes speech synthesis again; if it is “off”, that portion is inhibited from being output again.

The on/off states of the attributes defined in the speech synthesis control tags are set using, e.g., toggle buttons 1502 and 1503 in a frame 1501 in FIG. 15 implemented by the contents shown in FIG. 14.

In the frame 1501, the toggle button 1502 is used to issue a switching instruction as to whether or not the speech output and display of synthesis text which is to undergo speech synthesis are to be interlocked. Also, the toggle button 1503 is used to issue a switching instruction as to whether or not the already speech output portion is to undergo speech synthesis again. In accordance with the operation states of these toggle buttons, a control script in FIG. 13 controls to switch whether or not the speech output and display of synthesis text which is to undergo speech synthesis are to be interlocked and whether or not the already speech output portion is to undergo speech synthesis again.

As described above, according to the fifth embodiment, since the processes explained in the first to fourth embodiments can be implemented by contents described using a markup language with high versatility, the user can implement processes equivalent to those explained in the first to fourth embodiments using only a browser that can display the contents. Also, the device dependency upon implementing the processes explained in the first to fourth embodiments can be reduced, and the development efficiency can be improved.

The first to fifth embodiments may be arbitrarily combined to implement other embodiments according to the applications or purposes intended.

Note that the present invention includes a case wherein the invention is achieved by directly or remotely supplying a program of software that implements the functions of the aforementioned embodiments (a program corresponding to the flow charts shown in the respective drawings in the embodiments) to a system or apparatus, and reading out and executing the supplied program code by a computer of that system or apparatus. In this case, software need not have the form of program as long as it has the program function.

Therefore, the program code itself installed in a computer to implement the functional process of the present invention using the computer implements the present invention. That is, the present invention includes the computer program itself for implementing the functional process of the present invention.

In this case, the form of program is not particularly limited, and an object code, a program to be executed by an interpreter, script data to be supplied to an OS, and the like may be used as along as they have the program function.

As a recording medium for supplying the program, for example, a floppy disk, hard disk, optical disk, magnetooptical disk, MO, CD-ROM, CD-R, CD-RW, magnetic tape, nonvolatile memory card, ROM, DVD (DVD-ROM, DVD-R), and the like may be used.

As another program supply method, the program may be supplied by establishing connection to a home page on the Internet using a browser on a client computer, and downloading the computer program itself of the present invention or a compressed file containing an automatic installation function from the home page onto a recording medium such as a hard disk or the like. Also, the program code that forms the program of the present invention may be segmented into a plurality of files, which may be downloaded from different home pages. That is, the present invention includes a WWW server which makes a plurality of users download a program file required to implement the functional process of the present invention by a computer.

Also, a storage medium such as a CD-ROM or the like, which stores the encrypted program of the present invention, may be delivered to the user, the user who has cleared a predetermined condition may be allowed to download key information that decrypts the program from a home page via the Internet, and the encrypted program may be executed using that key information to be installed on a computer, thus implementing the present invention.

The functions of the aforementioned embodiments may be implemented not only by executing the readout program code by the computer but also by some or all of actual processing operations executed by an OS or the like running on the computer on the basis of an instruction of that program.

Furthermore, the functions of the aforementioned embodiments may be implemented by some or all of actual processes executed by a CPU or the like arranged in a function extension board or a function extension unit, which is inserted in or connected to the computer, after the program read out from the recording medium is written in a memory of the extension board or unit.

As many apparently widely different embodiments of the present invention can be made without departing from the spirit and scope thereof, it is to be understood that the invention is not limited to the specific embodiments thereof except as defined in the appended claims.

1-21. (canceled)

22. An information processing apparatus comprising:
display control means for controlling to display contents data to a display area;
change means for changing a display portion of the contents data within the display area;
display portion information holding means for holding display portion information indicating the display portion;
determination means for determining data, which is to undergo speech synthesis in the contents data, on the basis of the display portion information;
speech synthesis means for synthesizing speech of the data, which is to undergo speech synthesis, determined by said determination means; and
holding means for holding already output portion information indicating data synthesized and outputted by said speech synthesis means,
wherein said determination means inhibits the data indicated by the already output portion information held by said holding means from undergoing speech synthesis.

23. The apparatus according to claim 22, further comprising receiving means for receiving an instruction of designating the already output portion information.

24. The apparatus according to claim 22, further comprising deleting means for deleting the already output portion information held by said holding means.

25. The apparatus according to claim 22, further comprising output control means for outputting a speech for informing that said changing means changes the display portion during that process.

26. An information processing apparatus comprising:
display control means for controlling to display contents data to a display area;
change means for changing a display portion of the contents data within the display area;
display portion information holding means for holding display portion information indicating the display portion;
determination means for determining data displayed in the display area, and data which relates to contents data displayed in the display area and is not displayed in the display area, as being data to undergo speech synthesis; and
speech synthesis means for synthesizing speech of the data determined by said determination means.

27. The apparatus according to claim 26, wherein said contents data includes a text, and
said determination means, if a part of a sentence in the text is not displayed, determines that the sentence is to undergo speech synthesis.

28. An information processing method comprising:
a display control step of controlling to display contents data to a display area;
a change step of changing a display portion of the contents data within the display area;
a display portion information holding step of holding display portion information indicating the display portion;
a determination step of determining data, which is to undergo speech synthesis in the contents data, on the basis of the display portion information;
a speech synthesis step of synthesizing speech of the data, which is to undergo speech synthesis, determined in said determination step; and
a holding step of holding already output portion information indicating data synthesized and outputted in said speech synthesis step,
wherein in said determination step, the data indicated by the already output portion information held in said holding step is inhibited from undergoing speech synthesis.

29. An information processing method comprising:
a display control step of controlling to display contents data to a display area;
a change step of changing a display portion of the contents data within the display area;
a display portion information holding step of holding display portion information indicating the display portion;
a determination step of determining data displayed in the display area, and data which relates to contents data displayed in the display area and is not displayed in the display area, as being data to undergo speech synthesis; and
a speech synthesis step of synthesizing speech of the data determined in said determination step.

30. A program comprising:
a program code of a display control step of controlling to display contents data to a display area;
a program code of a change step of changing a display portion of the contents data within the display area;
a program code of a display portion information holding step of holding display portion information indicating the display portion;
a program code of a determination step of determining data, which is to undergo speech synthesis in the contents data, on the basis of the display portion information;
a program code of a speech synthesis step of synthesizing speech of the data, which is to undergo speech synthesis, determined in said determination step; and
a program code of a holding step of holding already output portion information indicating data synthesized and outputted in said speech synthesis step,
wherein in said determination step, the data indicated by the already output portion information held by said holding step is inhibited from undergoing speech synthesis.

31. A program comprising:
a program code of a display control step of controlling to display contents data to a display area;
a program code of a change step of changing a display portion of the contents data within the display area;
a program code of a display portion information holding step of holding display portion information indicating the display portion;
a program code of a determination step of determining data displayed in the display area, and data which relates to contents data displayed in the display area and is not displayed in the display area, as data being to undergo speech synthesis; and
a program code of a speech synthesis step of synthesizing speech of the data determined by said determination step.
